(19) United States
(12) Patent Application Publication
(10) Pub. No.: US 2018/0165725 A1
(43) Pub. Date: Jun. 14, 2018

(54) APPARATUS AND METHOD

(71) Applicant: Sony Corporation, Tokyo (JP)

(72) Inventors: Hugo EMBRECHTS, Stuttgart (DE); Tom Hostyn, Stuttgart (DE)

(73) Assignee: Sony Corporation, Tokyo (JP)

(21) Appl. No.: 15/826,968

(22) Filed: Nov. 30, 2017

(30) Foreign Application Priority Data
Dec. 12, 2016 (EP) 16203517.4

(51) Int. Cl. G06Q 30/02

(52) U.S. Cl. CPC G06Q 30/0282

(57) ABSTRACT

An apparatus has circuitry, which has:
a rating data circuit configured to obtain rating data from at least one application running on the apparatus or another apparatus; and
a recommendation data circuit configured to obtain recommendation data, wherein the recommendation data are generated, based on a collaborative filtering of the rating data.

### TECHNICAL FIELD

The present disclosure generally pertains to an apparatus and a method which can be used in the field of recommendation.

### TECHNICAL BACKGROUND

Typically, existing recommendation systems need an explicit linking of a user to associated user behavior data on the basis of which recommendations are generated.

Also in cases where user behavior data are collected from different applications used by the user, a link between the user and the data is typically necessary.

Although there exist techniques for recommendation, it is generally desirable to provide an improved apparatus and method, e.g. for providing recommendations.

### SUMMARY

According to a first aspect, the disclosure provides an apparatus comprising circuitry including a rating data circuit configured to obtain rating data from at least one application running on the apparatus or another apparatus, and a recommendation data circuit configured to obtain recommendation data, wherein the recommendation data are generated, based on a collaborative filtering of the rating data.

According to a second aspect, the disclosure provides a method for controlling an apparatus, comprising obtaining rating data from at least one application running on the apparatus or another apparatus, and obtaining recommendation data, wherein the recommendation data are generated, based on a collaborative filtering of the rating data.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 illustrates a smartphone and a server;

FIG. 2 illustrates an agent providing rating data to an agent platform;

FIG. 3 illustrates multiple smartphones providing rating data to a smartphone;

FIG. 4 illustrates another apparatus for running applications and an agent; and

FIG. 5 shows a flow chart of a recommendation method.

### DETAILED DESCRIPTION OF EMBODIMENTS

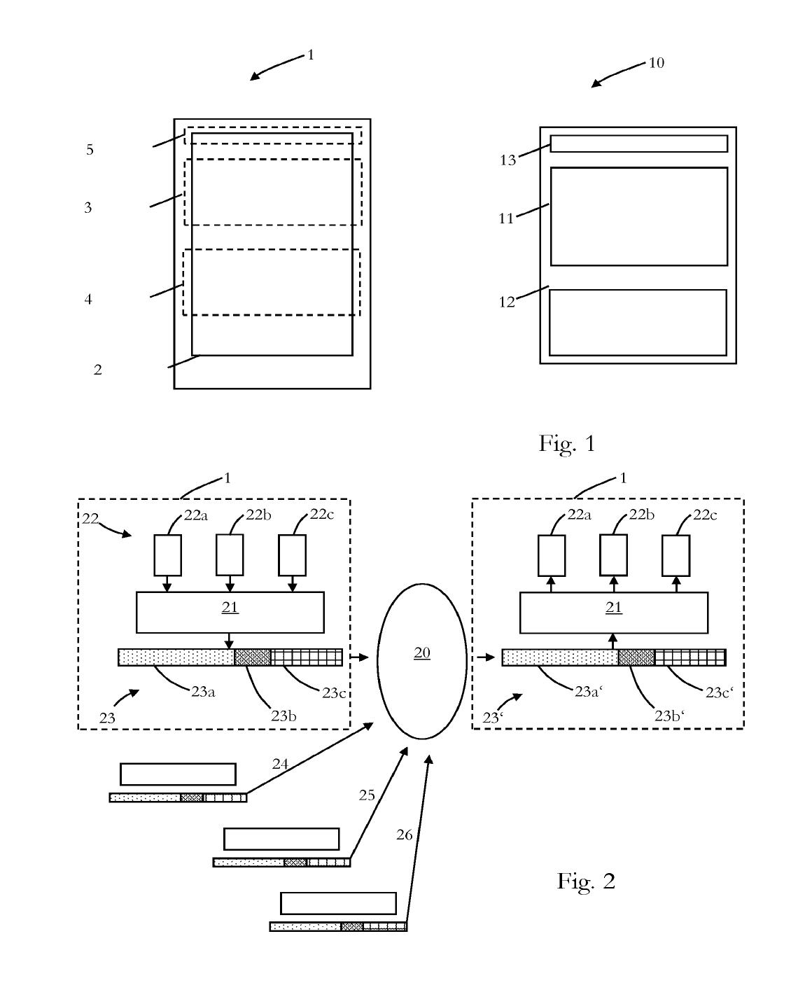

Before a detailed description of the embodiments under reference of FIG. 1 is given, general explanations are made.

As mentioned in the outset, typically, existing recommendation systems need an explicit linking of a user to associated user behavior data on the basis of which recommendations are generated.

Also in cases where user behavior associated data are collected from different applications used by the user, a link between the user and the data is typically necessary.

In more detail, in known concepts of cross-application recommendations the participating applications typically feed recorded ratings together with a user identity (ID) to a recommendation engine or the like. Generally, this user ID is the same for corresponding users across the different applications. Applications running on different devices may be associated with different user IDs although the natural user is the same.

Without using such a user ID, known recommendation systems typically would not be able to link users, and, thus, would not be able to provide cross-application recommendations. If such a user ID is used, however, cross-application end user linking is difficult to implement without compromising privacy of end users, since, for example, the user ID together with the user rating data are centrally stored at a server, such that the user docs not have any control about is personal information. Moreover, end users typically do not want to consent to recommendation systems which do not guarantee privacy.

On the other hand, cross-application recommendation systems for agents may allow that an agent offers for newly installed applications personalized recommendations from the (first) start by using the personal information built up by the other applications. This is also referred to as cold-start problem. Furthermore, recommendations within isolated application domains may also be less rich than cross-application recommendations.

Thus, some embodiments pertain to an apparatus comprising circuitry configured to obtain rating data from at least one application running on the apparatus or another apparatus, and to obtain recommendation data, wherein the recommendation data are generated, based on a collaborative filtering of the rating data. In some embodiments, more specifically, the circuitry includes a rating data circuit configured to obtain rating data from at least one application running on the apparatus or another apparatus and a recommendation data circuit configured to obtain recommendation data, wherein the recommendation data are generated, based on a collaborative filtering of the rating data.

The apparatus may be an electronic device, a mobile electronic device (e.g. telephone, smartphone, laptop computer, tablet computer, etc.), a personal computer, a server, a robot, etc. The apparatus may also be configured as an agent device, which may include, for example, voice recognition and which is able to react to commands received by voice. The apparatus may be configured to be used in home automation, e.g. for controlling electronic devices of a smart home, e.g. light, roller shutters, heating, etc.

The circuitry may include one or more processors, one or more microprocessors, dedicated circuits, logic circuits, interfaces (e.g. for local area network, wireless network, Bluetooth, infrared, etc.), user interfaces (e.g. keyboard, mouse, touchscreen, etc.), display means (liquid crystal display, (organic) light emitting diode based display), etc.

The rating data circuit may include one or more processors, one or more microprocessors, dedicated circuits, logic circuits or the like, which may be, in some embodiments, specifically designed for generating rating data, whereby power consumption and processing time may be reduced compared to performing it on a multi-purpose processor. Moreover, the rating data circuit may include an interface, e.g. For local area network, wireless network, Bluetooth, infrared, etc., which may be specifically designed for communication with applications running on the apparatus or on another apparatus. Moreover, the interface may be adapted to communicate with other circuits included in the circuitry.

The recommendation data circuit may include one or more processors, one or more microprocessors, dedicated circuits, logic circuits or the like, which may be, in some embodiments, specifically designed for generating recommendation data, whereby power consumption and processing time may be reduced compared to performing it on a multi-purpose processor. Moreover, the recommendation data circuit may include an interface, e.g. for local area network, wireless network, Bluetooth, infrared, etc., which may be specifically designed for communication with applications running on the apparatus or on another apparatus. Moreover, the interface may be adapted to communicate with other circuits included in the circuitry.

An application may be a software program which can be executed by a processor of an apparatus. The rating data is generated by an associated application. The meaning of the rating data may only be known by the application which generated the rating data.

Hence, in some embodiments, the rating data can only be interpreted by the application which generated it. The rating data may include numbers or the like, wherein each number indicates, e.g. for a certain item, a certain type of items, whether a user likes the associated item, whether he bought it, used it etc.

For example, a restaurant application may help a user to find a restaurant and to make a reservation. The rating data may then include numbers, which indicate, whether a specific restaurant and/or a specific type of restaurant is often used by a user or not.

For example, assuming that only a specific type of restaurant is used for generation of the rating data, the following exemplary scheme can be used.

The number “0” means that the specific type of restaurant is never searched for (visited), while the number “9” is the highest number and means that it is very often searched for (visited). Of course, the numbering as well as their meaning can be freely chosen. For example, only three numbers may be used, e.g. 1, 2 and 3, wherein “3” means never, “2” sometimes, and “1” often, etc.

For instance, for a user, who, for example, often times visits an Italian restaurant, sometimes a Chinese restaurant, but never a French restaurant, the restaurant application may provide rating data: “{9,5,0}”.

Hence, in some embodiments, the rating data does not even include any type of item description, but only numbers indicating different ratings, as in this example “{9,5,0}”.

Of course, this example has only been given for illustration purposes and different applications may use different schemes for generating the rating data.

The circuitry or its recommendation data circuit is further configured to obtain recommendation data, wherein the recommendation data are generated, based on a collaborative filtering of the rating data.

Based on the recommendation data, a recommendation may be displayed on a display and may include, for example, text, an icon, graphical representation of an item, sound, vibration of the device, or the like. The recommendation may be displayed from an application running on the apparatus, wherein the application may have received the recommendation data.

The recommendation data may be generated based on a collaborative filtering (algorithm), which uses the rating data, or data derived from the rating data, as input. The collaborative filtering (algorithm) may be based on a singular value decomposition, on a Bayesian Network, on clustering models or other approaches, which are known to the skilled person. The singular value decomposition may be performed on the rating data vector including the rating data, whereby, the dimensionality of the rating data vector may be reduced. As collaborative filtering and collaborative filtering algorithms are generally known, a further description is not necessary.

In some embodiments, the calculation of recommendations or recommendation data based on the collaborative filtering is performed by exchanging rating data of different applications of the same apparatus and/or of different applications of different users and/or apparatus. Thereby, a large data set of rating data may be obtained and a global collaborative filtering algorithm may be performed using the large data set of rating data as input data. In some embodiments, the applications themselves do not need to organize anything, in particular there is no need to transmit a user ID or the like.

In some embodiments, a more centralized approach is used, where rating data of all applications of a specific apparatus/user are collected and are concatenated to a (single) rating data vector as input for the collaborative filtering (algorithm).

In some embodiments, an agent or recommendation agent is used, which may be provided as a computer program which is performed by the circuit. The agent may collect rating data from applications running on the apparatus and may, for example, transmit it to an agent platform or the like, on which the collaborative filtering is performed.

Hence, in some embodiments, a cross-application recommendation is established without an explicit linking of users or user IDs or the like across applications.

In some embodiments, no end user ID is linked to the rating data, since, for example, an implicit linking of end users across applications is achieved by concatenating the rating data from all applications on a same agent device, before feeding the resulting collection of user ratings into the collaborative filtering.

In some embodiments, there is also no need to leave a trace of personal data (the input ratings) on, for example, a permanent storage outside the apparatus or agent (e.g. in the cloud). In some embodiments, input data are only needed during running of the collaborative filtering algorithm and they may be deleted afterwards.

In some embodiments, there is no need for application providers to set up a cloud server or the like for performing recommendations across the users of their application.

As also discussed above, in some embodiments, only the applications themselves know the “meaning” of their ratings and the associated rating data they pass to an entity, apparatus, agent platform or the like performing the collaborative filtering. Hence, there may be no need to trust in the integrity of the entity, apparatus, agent platform, etc.

In some embodiments, an application programming interface (API) is provided, which may be provided by the circuitry of the apparatus and/or which may be part of an agent and/or which may be part of an agent platform. Over the API, third party application providers may provide rating data, e.g. for collaborative filtering, and over the API, for example, an application may receive recommendation data on the basis of which a recommendation may be displayed. The API may be prescribed, for example, in a standardized manner. As a consequence, in some embodiments, the API and its features and details may be (fully) visible to anyone.

In some embodiments, on the basis of the rating data, a rating data vector is generated and the circuitry, e.g. its rating data circuit, may be further configured to generate a rating data vector, based on the obtained rating data. The rating data vector may simplify processing of rating data, whereby the overall processing time and power consumption of the circuitry may be reduced. Moreover, in embodiments, the rating data circuit may configured in hardware to generate the rating data vector, whereby the processing time and power consumption may be further reduced.

The rating data vector may include rating data from different applications. In some embodiments, the rating data vector is specific for a specific apparatus and/or user (and/or agent). For example, the rating data vector may only include rating data from applications running and/or being installed on the same apparatus and/or for the same user.

Hence, the rating data vector may be apparatus specific and/or user specific and/or agent specific, wherein, in some embodiments, the rating data vector does not include any user and/or apparatus information.

The rating data vector may include several sections in association with the applications from which the rating data are obtained.

For example, assuming that, e.g. rating data from four applications, namely application “A”, “B”, “C” and “D” are obtained or collected, then the rating data vector may include four sections, a first section for rating data obtained from application “A”, a second section for rating data obtained from application “B”, a third section for rating data obtained from application “C”, and a fourth section for rating data obtained from application “D”.

The recommendation data may be generated based on multiple rating data vectors, which are obtained from different apparatus and/or users and/or agents. As mentioned, in some embodiments, a rating data vector may be apparatus specific and/or user specific and/or agent specific and the recommendation data may be generated based on multiple rating data vectors which are obtained from different apparatus and/or users and/or agents.

The generation of the recommendation data may be performed by the apparatus, i.e. the circuitry, e.g. its recommendation data circuit, and/or by another apparatus, e.g. a server, which may be located in a network, in the internet or the like. As mentioned, the recommendation data circuit may be specifically, e.g. in hardware, configured to generate the recommendation data, whereby power consumption and processing time may be reduced.

Hence, in some embodiments, the apparatus and/or, for example, a method which may be implemented, e.g. by an agent platform which may be a computer program, collects from each application and/or participating apparatus rating data, as discussed above.

In some embodiments, the circuitry is further configured to generate the recommendation data and/or the circuitry is further configured to perform a collaborative filtering algorithm, wherein the circuitry may include a collaborative filtering circuit, which may be specifically configured to perform a collaborative filtering. Collaborative filtering may computation intensive and by adapting a circuit, e.g. in hardware, to a specific collaborative filtering algorithm, the processing time and power consumption may be reduced. The result of the collaborative filtering algorithm may be provided to the applications running on the apparatus and/or may be transmitted to another apparatus.

The collaborative filtering algorithm may provide (as a result) a data vector including recommendation data. A data vector may simplify necessary computations and may reduce the amount of communication necessary to provide it to the agent platform and/or the entity, which generates the recommendation data, e.g. the recommendation data circuit. In some embodiments, for each agent/apparatus/user a respective data vector is provided by the collaborative filtering, wherein the data vector is enriched with recommendations for each of the corresponding items in the rating data vector, which has been input to the collaborative filtering. Upon receiving this data vector, each agent, apparatus, application and/or other entity splits the data vector again, e.g. into parts being each associated with an application and transfers the corresponding parts to the respective applications.

As also indicated above, the rating data may be obtained from multiple applications running on the apparatus.

The circuitry, e.g. its rating data circuit, may be further configured to collect rating data from applications running on at least one other apparatus. Thereby, rating data from other apparatus/agents/users can be collected. As discussed, the rating data circuit may include an interface which is specifically adapted for collecting rating data from applications running on at least one other apparatus.

As also indicated above, the rating data may be based on user behavior of a user using the at least one application. In some embodiments, the at least one application analyzes the user behavior and generates the rating data. Moreover, the at least one application may also generate a recommendation based on the recommendation data obtained.

The circuitry, e.g. a display, may be further configured to display a recommendation, based on the recommendation data, wherein the recommendation may be displayed on a display of the apparatus.

As mentioned, in some embodiments, an (or one) application runs on the apparatus and provides a recommendation, wherein the recommendation is based on the rating data from another (e. g. the at least one) application running on another apparatus. Thereby, the cross-application recommendation discussed herein is implemented in some embodiments.

Some embodiments pertain to a method, comprising obtaining rating data from at least one application running on an apparatus, and obtaining recommendation data, wherein the recommendation data are generated, based on a collaborative filtering of the rating data. The method may be performed by the apparatus (circuitry) as discussed herein or by any other electronic processing device. The method may include the features as of the apparatus described herein. The method may comprise generating a rating data vector, based on the obtained rating data, as also discussed above. It may further comprise generating the recommendation data, as discussed above. It may further comprise performing a collaborative filtering algorithm, as discussed above, and the collaborative filtering algorithm may provide a data vector including recommendation data. The rating data may be obtained from multiple applications running on the apparatus, as discussed above. The method may further comprise collecting rating data from applications running on at least one other apparatus, as discussed above. The rating data may be based on user behavior of a user using the at least one application, as discussed above. The method may further comprise displaying a recommendation, based on the recommendation data, as discussed above. An application running on the apparatus may provide a recommendation, based on the rating data from the at least one application running on another apparatus.

The methods as described herein are also implemented in some embodiments as a computer program causing a computer and/or a processor and/or a circuitry to perform the method, when being carried out on the computer and/or processor and/or circuitry. In some embodiments, also a non-transitory computer-readable recording medium is provided that stores therein a computer program product, which, when executed by a processor/circuitry such as the processor/circuitry described above, causes the methods described herein to be performed.

Returning to FIG. 1, there is illustrated an apparatus 1, which is configured as a smartphone. The smartphone has a display 2, which is based on LED-technology and which is configured as a touch screen.

The smartphone has a processor 3, which is connected to a storage 4 and an interface 5. The storage 4 includes a random access memory and a flash storage. The interface 5 is adapted to communicate with a mobile telecommunications system, e.g. LTE, GSM or the like. It is also adapted to perform a wireless communication with a wireless local area network and, for example, to communicate over Bluetooth. Thereby, the smartphone 1 can establish a connection to the internet.

The display 2, the processor 3, the storage 4 and the interface 5 may form a circuitry as discussed herein.

An agent, which is configured as a computer program, may be performed by the processor (circuitry) of the smartphone 1 as well as a couple of applications, which perform different functions.

Moreover, another apparatus 10 is illustrated, which is configured as a server. The server 10 has a processor 11, a storage 12 and an interface 13. The processor 11, the storage 12 and the interface 13 may form a circuitry.

The storage 12 includes a random access memory and a hard disk.

The interface 13 is configured to provide access to a local area network (LAN). The LAN can be connected to the internet.

Hence, the smartphone 1 and the server 10 can communicate over a network and/or the internet with each other.

An agent platform may be executed by the server 10. The interplay of an agent platform 20 and agents, such as agent 21, is further discussed under reference of FIG. 2. More generally and as also discussed above, the agent platform may be a platform for applications, which handles the rating data received from different applications. Hence, the agent forming the agent platform may also run on a specific device and collect the rating data from the applications running on this specific device.

Therefore, in some embodiments, the specific device on which the agent runs which acts as an agent platform may be regarded itself as an agent platform (device).

The agent platform 20 is located on the server 10 and it is a computer program, which is stored in storage 12 and executed by the processor 11 of the server 10.

The agent 21 is a computer program, which is stored in storage 4 and executed by the processor 3 of the smartphone 1.

Moreover, several applications 22 are installed on smartphone 1, wherein three applications, applications 22a, 22b and 22c are exemplary illustrated in FIG. 2

For illustration purposes it is assumed, that application 22a is a restaurant guide, application 22b provides cooking recipes and application 22c is used for shopping by a user of the smartphone 1.

Each of the applications 22a, 22b and 22c generate rating data, based on the user behavior of the user using the applications 22a, 22b and 22c, and pass the rating data to the agent 21.

The agent 21 provides an API, which is standardized such that the applications 22a, 22b and 22c can communicate with the agent 21 and can provide, for example, the rating data in a predefined data format to the agent 21.

Agent 21 concatenates the rating data provided from the applications 22a, 22b and 22c to a rating data vector 23.

The rating data vector 23 includes rating data 23a from application 22a, rating data 23b from application 22b and rating data 23c from application 22c.

Each rating data includes ratings from the associated applications 22a, 22b, and 22c.

For example, the rating data 23a from the application 22a, which is a restaurant guide, provides ratings for different restaurants, e.g. “5” for restaurant A, “1” for restaurant B, “2” for restaurant C, etc. Hence, the rating data 23a has the following content: “{5,1,2}”.

The rating data 23b from the application 22b, which provides cooking recipes, provides ratings for different recipes, e.g. “9” for recipe A, “0” for recipe B, “4” for recipe C, etc. Hence, the rating data 23b has the following content: “{9,0,4}”.

The rating data 23c from the application 22c, which is used for shopping, provides ratings for different items bought by the user using application 22c, e.g. “7” for item A, “2” for item B, “5” for item C. Hence, the rating data 23c has the Following content: “{7,2,5}”.

In summary, the rating data vector 23 has the content of rating data 23a, 23b and 23c: “{5,1,2,9,0,4,7,2,5}”. The rating data 23a, 23b and 23c and/or the rating data vector 23 may be stored in the storage 4 of the smartphone.

The rating data vector 23 is transmitted to the agent platform 20 running on the server 10.

The agent 21 does not know the meaning of the rating data 23a, 23b and 23c, respectively, such that also the meaning of the rating data vector is unknown to the agent 21, and, thus, also to the agent platform 20, which is fully agnostic of meaning of preferences/ratings received and used for the collaborative filtering.

The agent platform 20 collects rating data vector 23 and other rating data vectors, such as rating data vectors 24, 25 and 26 from other agents running on other apparatus, and performs a collaborative filtering, based on the multiple rating data vectors 23-26 collected from different apparatus.

The result of the collaborative filtering is a rating data vector 23′, which is enriched with ratings (recommendation data) resulting from performing a collaborative filtering algorithm using the collected rating data vectors 23-26 as input data.

Before the collaborative filtering is performed, a dimension reduction through singular value decomposition may be performed for the collected rating data vectors 23-26.

During the collaborative filtering, correlations between rating data, which are associated to a specific application, but which are collected from different agents (e.g. users, apparatus), can be found without the need of the information to which item, for example, the respective rating data belongs and/or from which user the rating data stems.

The general order of the rating data in the rating data vector may be identical for a specific application (e.g. rating for item A, rating for item B, rating for item C, etc.) and, moreover, in some embodiments, also the order of the application rating data within the rating data vectors from different agents may be identical. For example, rating data for application A, rating data for application B, rating data for application C, etc., may be in the order A-B-C in the rating data vector. Thereby, by correlating multiple rating data vectors with each other by performing the collaborative filtering, correlations between common preferences within the data can be found without having any knowledge about items, user ID or the like.

The rating data vector 23′ provided back from the agent platform 20 to the agent 21 includes enriched rating data 23a′, 23b′ and 23c′, which include recommendation data, wherein the recommendation data may also be only provided as numbers, i.e. in a similar manner as the rating data included in the rating data vectors.

The agent 21 splits the rating data vector 23′ into the respective parts 23a′, 23b′ and 23c′ and passes the parts to the applications 22a, 22b and 22c, respectively.

The applications 22a, 22b and 22c analyze the enriched rating data 23a′, 23b′ and 23c′, extract the recommendation data included by the collaborative filtering algorithm, and may provide, based on the recommendation data, a respective recommendation to the user, e.g. by displaying it on the display 2. The recommendation may include graphic elements, text elements, sound elements, vibration elements, etc.

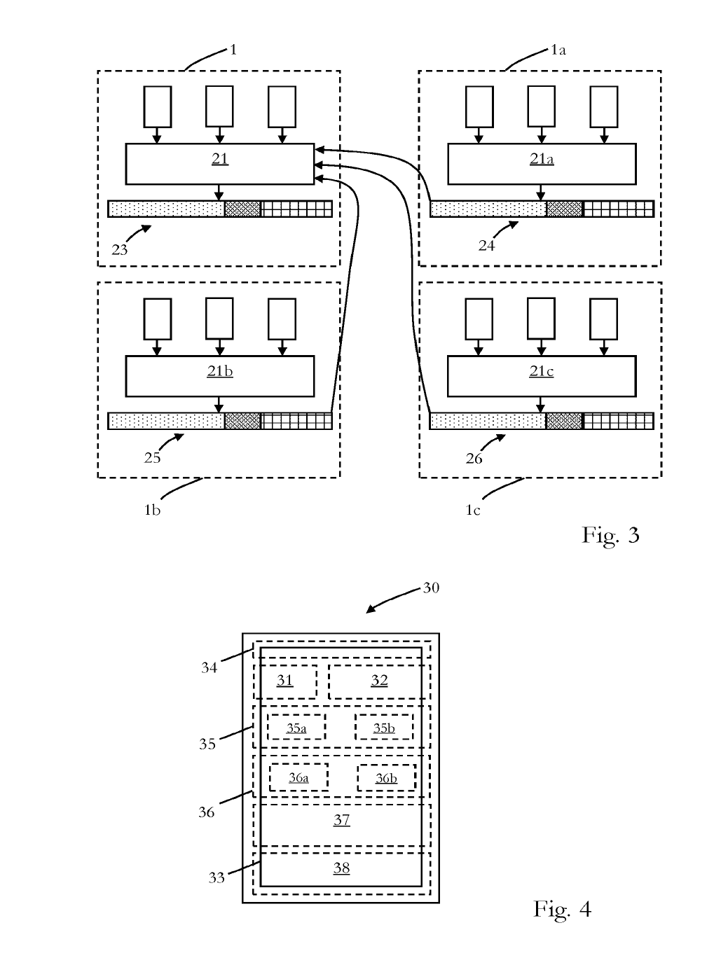

FIG. 3 illustrates another embodiment, wherein multiple agents 21, 21a, 21b, 21c are running on multiple apparatus 1, 1a, 1b and 1c, such as smartphone 1 of FIG. 1, wherein rating data vectors 23, 24, 25 and 26 are used for collaborative filtering, which is performed, e.g. on smartphone 1.

Hence, in this embodiment, a centralized server may be omitted, such as server 10 of FIG. 1, which executes an agent platform, such as the agent platform of FIG. 2.

As explained under reference of FIG. 2, on each of the smartphones 1, 1a, 1b and 1c, multiple applications are performed, which can provide rating data, which are then combined, e.g. by a respective agent 21, 21a, 21b and 21c, respectively, to a rating data vector 23, 24, 25 and 26, respectively.

The agent 21 of smartphone 1 collects the rating data vectors 24, 25 and 26 from the other smartphones 1a, 1b and 1c and performs a collaborative filtering algorithm, as it has been explained under reference of FIG. 2. Thereby, an enriched rating data vector 23′, as discussed for FIG. 2, is obtained, which includes recommendation data, which can be used by applications 22a, 22b and 22c, respectively, for providing a recommendation to a user.

Of course, also the other smartphones 1a, 1b and/or 1c may collect rating data vectors and may perform a collaborative filtering.

In some embodiments, the collaborative filtering may be performed by all or a subset of apparatus participating in a common system for providing recommendation data in a distributed manner.

Hence, in some embodiments, the applications do not receive any information about other applications. As mentioned, an application vendor may not have to set up a cloud service to achieve collaborative filtering (although they could use their own system in combination with the mechanism proposed herein). Moreover, for the agent platform the rating data vectors, which may be combined to rating data arrays, are like an opaque list of numbers without meaning, and, thus, the agent platform is agnostic of application data in some embodiments.

In some embodiments, recorded preferences/ratings are stored only locally on the apparatus, but not, for example, on a server or the like.

Although the collaborative filtering is performed in the cloud, in some embodiments, it does not leave any permanent traces on permanent cloud storage. Therefore, a security breach of a cloud server may not reveal any personal information.

In the following an apparatus 30 is explained, which may also form the basis for a smartphone, server, computer or the like, such as the smartphone 1, 1a, 1b, 1c and the server 10 discussed above.

The apparatus 30 has a process 31, a storage 32 and a display 33 and an interface, similar to processor 3, storage 4, display 3 and interface 5 of smartphone 1 of FIG. 1. Moreover, the apparatus 30 has a rating data circuit 35, a recommendation data circuit, a collaborative filtering circuit 37, and an application circuit 38, wherein entities 35 to 38 may communicate with 31 and/or 38 over an internal bus or the like.

The rating data circuit 35 has a rating data generator 35a, which may be based on a processor, logic circuits and the like, and an interface 35b over which it can communicate the rating data, an/or receive rating data.

The recommendation data circuit 36 has a recommendation data generator 36a, which may be based on a processor, logic circuits and the like, and an interface 36b over which it can communicate the recommendation data, and/or receive recommendation data.

The collaborative filtering circuit 37 may be based on a processor, logic circuits and the like, and it may be specifically designed for performing a specific collaborative filtering algorithm, e.g. singular value decomposition or the like.

The application circuit 38 may be based on a processor, logic circuits and the like, and it may be specifically designed for performing applications.

As also discussed above, the applications running on the application circuit may provide rating data, e.g. to the rating data circuit 35, which receives the rating data over its interface 35b and generates a rating data vector with its rating data generator 35a. Of course, the rating data circuit 35 may also receive rating data from applications from other apparatus over its interface 35b.

The rating data circuit 35 communicates that rating data vector(s) over its interface to the collaborative filtering circuit 37 which performs collaborative filtering, as it has been explained under reference of FIG. 2. Thereby, an enriched rating data vector, as discussed for FIG. 2, is obtained, which is communicated to the recommendation data circuit 36 and received, for example, over the interface 36b.

The recommendation data generator 36a generates recommendation data which can be displayed on the display 33, as discussed herein. The recommendation data may be displayed by an application running on the application circuit 38 or by another program which is performed, for example, by processor 31.

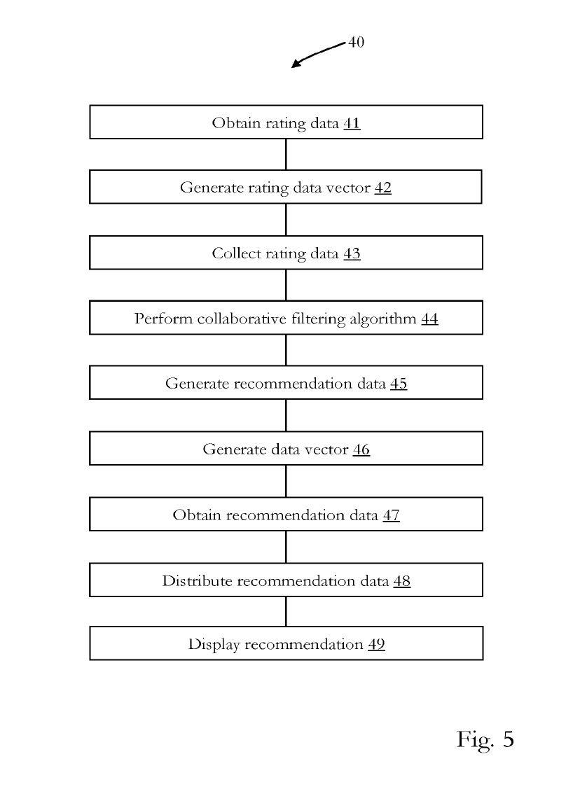

In the following, a method 40 for providing a recommendation is discussed under reference of FIG. 5, which can be performed by an apparatus/circuitry (e.g. smartphone 1 and/or 1a, 1b, 1c, 30 (e.g. 31 to 38)), or by a system/circuitries (e.g. smartphone 1 and server 10 or smartphones 1, 1a, 1b, and/or 1c, 30 (e.g. 31 to 38)), as described herein.

At 41, rating data are obtained from at least one or multiple applications, e.g. applications 22a, 22b and 22c of FIG. 1, running on an apparatus, e.g. smartphone 1, as discussed above. The rating data may be obtained by rating data circuit 35, as discussed above. As mentioned, the rating data may be based on user behavior of a user using the at least one application.

At 42, a rating data vector is generated, based on the obtained rating data, which can be done, e.g. by an agent, such as agent 21, as discussed above. The rating data vector may be generated by rating data generator 35a of rating data circuit, as discussed above.

At 43, rating data are collected from at least one other apparatus, as discussed above. For example, server 10 collects rating data (vectors) 23-26 from different apparatus (FIG. 2) or smartphone 1 collects rating data (vectors) from smartphones 1a, 1b and 1c (FIG. 3). The rating data may be collected by the rating data circuit 35, as discussed above.

At 44, a collaborative filtering algorithm, e.g. based on singular value decomposition is performed on data, which are provided to the collaborative filtering algorithm, e.g. the rating data collected at 33, as discussed above. The collaborative filtering may be performed by the collaborative filtering circuit 37.

At 45 recommendation data are generated, as discussed above, as a result from or based on the collaborative filtering algorithm. This may be performed by the recommendation data generator 36a.

At 46, the collaborative filtering algorithm or another entity, such as the recommendation data generator provides a data vector including the recommendation data, as discussed above. Providing the recommendation data may include providing the recommendation data (vector) back, for example, to single (agent) devices, e.g. smartphone 1 or 1a-c.

At 47, the data vector of 47 is obtained, and thus the recommendation data are obtained, as also discussed above. The recommendation data may also be obtained by the recommendation data circuit 36.

At 48, the recommendation data may be distributed to single applications running on a specific device. This may be performed, for example, by the recommendation circuit 36, which sends recommendation data to the application circuit 38 (in other embodiments, the application circuit 38 may be configured to distribute the recommendation data accordingly to the applications running on the application circuit 38).

At 49, a recommendation is displayed, based on the recommendation data. As discussed above, the recommendation may be displayed by the at least one application.

Hence, in some embodiments, a recommendation of an application to its user(s) may be more individually targeted.

In some embodiments, the cold start problem is solved, since, when a user installs a new application, the new application can benefit from knowledge gathered by the other applications that are already in use on the device. In other words, the data vector returned back from the collaborative filtering may include recommendation data also for the new application.

It should be recognized that the embodiments describe methods with an exemplary ordering of method steps. The specific ordering of method steps is however given for illustrative purposes only and should not be construed as binding.

It is noted that the division of the circuitry into units 2 to 5 for smartphone 1 and into units 11 to 13 for server 10 is only made for illustration purposes and that the present disclosure is not limited to any specific division of functions in specific units. For instance, the circuitry could be implemented by a respectively programmed processor, field programmable gate array (FPGA) and the like.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using a software-controlled data processing apparatus, it will be appreciated that a computer program providing such software control and a transmission, storage or other medium by which such a computer program is provided are envisaged as aspects of the present disclosure.

Note that the present technology can also be configured as described below.

(1) An apparatus comprising circuitry including:

a rating data circuit configured to obtain rating data from at least one application running on an apparatus; and

a recommendation data circuit configured to obtain recommendation data, wherein the recommendation data are generated, based on a collaborative filtering of the rating data.

(2) The apparatus of (1), wherein the rating data circuit is further configured to generate a rating data vector, based on the obtained rating data.
(3) The apparatus of (1) or (2), wherein the recommendation data circuit is further configured to generate the recommendation data.
(4) The apparatus of anyone of (1) to (3), the circuitry further including a collaborative filtering circuit configured to perform a collaborative filtering algorithm.
(5) The apparatus of (4), wherein the collaborative filtering algorithm provides a data vector including recommendation data.
(6) The apparatus of anyone of (1) to (5), wherein rating data is obtained from multiple applications running on the apparatus.
(7) The apparatus of anyone of (1) to (6), wherein the rating data circuit is further configured to collect rating data from applications running on at least one other apparatus.
(8) The apparatus of anyone of (1) to (7), wherein the rating data is based on user behavior of a user using the at least one application.
(9) The apparatus of anyone of (1) to (8), the circuitry further including a display for displaying a recommendation, based on the recommendation data.
(10) The apparatus of anyone of (1) to (9), wherein an application running on the apparatus provides a recommendation, based on the rating data from the at least one application running on another apparatus.
(11) A method for controlling an apparatus, comprising:

obtaining rating data from at least one application running on the apparatus or another apparatus; and

obtaining recommendation data, wherein the recommendation data are generated, based on a collaborative filtering of the rating data.

(12) The method of (11), further comprising generating a rating data vector, based on the obtained rating data.
(13) The method of (11) or (12), further comprising generating the recommendation data.
(14) The method of anyone of (11) to (13), further comprising performing a collaborative filtering algorithm.
(15) The method of (14), wherein the collaborative filtering algorithm provides a data vector including recommendation data.
(16) The method of anyone of (11) to (15), wherein rating data is obtained from multiple applications running on the apparatus.
(17) The method of anyone of (11) to (16), further comprising collecting rating data from applications running on at least one other apparatus.
(18) The method of anyone of (11) to (17), wherein the rating data is based on user behavior of a user using the at least one application.
(19) The method of anyone of (11) to (18), further comprising displaying a recommendation, based on the recommendation data.
(20) The method of anyone of (11) to (19), wherein an application running on the apparatus provides a recommendation, based on the rating data from the at least one application running on another apparatus.
(21) A computer program comprising program code causing a computer to perform the method according to anyone of (11) to (20), when being carried out on a computer.
(22) A non-transitory computer-readable recording medium that stores therein a computer program product, which, when executed by a processor, causes the method according to anyone of (11) to (20) to be performed.

The present application claims priority to European Patent Application 16203517.4 filed by the European Patent Office on 12 Dec. 2016, the entire contents of which being incorporated herein by reference.

1. An apparatus comprising circuitry including:
a rating data circuit configured to obtain rating data from at least one application running on the apparatus or another apparatus; and
a recommendation data circuit configured to obtain recommendation data, wherein the recommendation data are generated, based on a collaborative filtering of the rating data.

2. The apparatus of claim 1, wherein the rating data circuit is further configured to generate a rating data vector, based on the obtained rating data.

3. The apparatus of claim 1, wherein the recommendation data circuit is further configured to generate the recommendation data.

4. The apparatus of claim 1, the circuitry further including a collaborative filtering circuit configured to perform a collaborative filtering algorithm.

5. The apparatus of claim 4, wherein the collaborative filtering algorithm provides a data vector including recommendation data.

6. The apparatus of claim 1, wherein rating data is obtained from multiple applications running on the apparatus.

7. The apparatus of claim 1, wherein the rating data circuit is further configured to collect rating data from applications running on at least one other apparatus.

8. The apparatus of claim 1, wherein the rating data is based on user behavior of a user using the at least one application.

9. The apparatus of claim 1, the circuitry further including a display for displaying a recommendation, based on the recommendation data.

10. The apparatus of claim 1, wherein an application running on the apparatus provides a recommendation, based on the rating data from the at least one application running on another apparatus.

11. A method for controlling an apparatus, comprising:
obtaining rating data from at least one application running on the apparatus or another apparatus; and
obtaining recommendation data, wherein the recommendation data are generated, based on a collaborative filtering of the rating data.

12. The method of claim 11, further comprising generating a rating data vector, based on the obtained rating data.

13. The method of claim 11, further comprising generating the recommendation data.

14. The method of claim 11, further comprising performing a collaborative filtering algorithm.

15. The method of claim 14, wherein the collaborative filtering algorithm provides a data vector including recommendation data.

16. The method of claim 11, wherein rating data is obtained from multiple applications running on the apparatus.

17. The method of claim 11, further comprising collecting rating data from applications running on at least one other apparatus.

18. The method of claim 11, wherein the rating data is based on user behavior of a user using the at least one application.

19. The method of claim 11, further comprising displaying a recommendation, based on the recommendation data.

20. The method of claim 11, wherein an application running on the apparatus provides a recommendation, based on the rating data from the at least one application running on another apparatus.
